(19) United States
(12) Patent Application Publication
(10) Pub. No.: US 2003/0026657 A1
(43) Pub. Date: Feb. 6, 2003

(54) Apparatus and method for controlling the start up and phase relationship between eccentric assemblies

(75) Inventors: Kenneth E. Gasper, Chambersburg, PA (US); Dale W. Starry, Shippensburg, PA (US); Chad L. Fluent, St. Thomas, PA (US)

Correspondence Address: David R. Price, Michael Best & Friedrich LLP, Suite 360, 3773 Corporate Parkway, Center Valley, PA, 18034, US

(73) Assignee: Ingersoll-Rand Company, Woodcliff Lake, NJ (US)

(21) Appl. No.: 09/875,598

(22) Filed: Jun. 6, 2001

(51) Int. Cl. G09D 3/10

(52) U.S. Cl. 404/117

(57) ABSTRACT

The vibration compacting machine includes a frame, a leading drum and a trailing drum. The leading and trailing drums are rotatably mounted to the frame. The leading drum includes a first eccentric assembly that is rotatably mounted inside of the leading drum and the trailing drum includes a second eccentric assembly that is rotatably mounted inside the trailing drum. A first motor rotates the first eccentric assembly and a second motor rotates the second eccentric assembly. Rotations of the eccentric assemblies transfers vibrations to the drums to compact a ground surface. A control adjusts the speed of the first and second motor relative to one another to keep the first eccentric assembly from running in phase with the second eccentric assembly. The control also delays starting the second eccentric assembly relative to the first eccentric assembly to minimize horsepower drain on the engine of the vibration compacting machine.

### FIELD OF THE INVENTION

The invention relates to vibration compacting machines, and more particularly to an apparatus and method for controlling the start times and phase relationship between eccentric assemblies within the compacting drums on a double drum vibration compacting machine.

### BACKGROUND OF THE INVENTION

Vibration compacting machines are used for compacting paved or unpaved ground surfaces. A typical vibration compacting machine includes leading and trailing ground-engaging drums that are rotatably mounted to a frame of the vibration compacting machine. The ground-engaging drums commonly include an eccentric assembly that is mounted inside of each drum such that rotation of the individual eccentric assemblies produces vibrations that are transferred to the respective drums. The individual eccentric assemblies are usually rotatably driven by separate hydraulic motors that are supplied with hydraulic oil from a common hydraulic pump which is powered by the engine of the vibration compacting machine.

Since the two eccentric assemblies are driven by separate motors, the eccentric assemblies are not synchronized with each other and rotate at different speeds. As a result of rotating the eccentric assemblies at different speeds, the eccentric assemblies move in and out of phase relative to one another. When the eccentric assemblies are in phase with each other, or nearly in phase with each other, the eccentric assemblies emit an amplified noise that is offensive to an operator of the vibration compacting machine. An in-phase relationship between the eccentric assemblies also creates excessive vibrations that are transferred to the machine frame and the operator's station.

U.S. Pat. No. 3,871,788 discloses a vibration compacting machine that has the eccentric assemblies mounted outside of the drums to produce vibrations that are transferred to the drum. The eccentric assemblies each include eccentric weights that are mounted above each drum and rotatably driven by a single motor. The eccentric assemblies are coupled together for synchronized rotation approximately 180° apart from each other. The single motor rotates both eccentric assemblies outside of the drums because the eccentric assemblies are coupled together with a simple mechanical linkage. Coupling the eccentric assemblies together fixes a constant phased relationship between the rotating eccentric assemblies.

Conventional vibration compacting machines include motors that simultaneously initiate driving the eccentric assemblies resulting in undesirable effects such as (i) a momentary reduction of engine speed; (ii) a discharge of black smoke from the engine exhaust indicating horsepower demand that exceeds available horsepower; (iii) a slowing down of the vibration compacting machine rolling speed; and (iv) a repetitive engagement and disengagement of vibration due to the rolling speed fluctuation.

The above-described devices are generally effective for creating vibrations and transferring the vibrations to the drums. Therefore, any improvement to such devices would be desirable.

### SUMMARY OF THE INVENTION

The vibration compacting machine of the present invention enhances operator comfort by providing a phase control system that prevents a first eccentric assembly which is positioned within a leading drum from rotating in phase with a second eccentric assembly which is positioned within a trailing drum. Preventing in phase rotation reduces undesirable noise levels and vibrations that are communicated to the operator's station during operation of the vibration compacting machine. The present invention also extends the service life of the vibration compacting machine by minimizing the transfer of potentially damaging vibrations to unprotected components on the vibration compacting machine.

The vibration compacting machine of the present invention increases engine efficiency by providing a control system that delays starting of one motor until after the power demand caused by starting another motor has peaked and dropped. Delaying the startup of one motor relative to another (i) optimizes the horsepower demand on the engine of the vibration compacting machine; (ii) reduces the frequency and intensity of engine power surges; (iii) increases the operating cycles of the vibration compacting machine before refueling; and (iv) extends the service life of the engine by preventing the engine from operating under peak load.

The present invention is directed to a vibration compacting machine for leveling paved or unpaved ground surfaces. The vibration compacting machine includes a frame, and a leading and trailing drum that are rotatably mounted to the frame. The leading drum includes a first eccentric assembly that is rotatably mounted inside of the leading drum and the trailing drum includes a second eccentric assembly that is rotatably mounted inside the trailing drum. A first motor rotates the first eccentric assembly to generate vibrations that are transferred to the leading drum and a second motor rotates the second eccentric assembly to generate vibrations that are transferred to the trailing drum. Transferring vibrations to the leading and trailing drums facilitates compacting the ground that the vibration compacting machine is riding on.

A control adjusts the speed of the first motor and the second motor relative to one another to keep the first eccentric assembly from running in phase with the second eccentric assembly. Keeping the first and second eccentric assemblies from running in phase prevents the eccentric assemblies from (i) emitting an amplified noise that is offensive to the operator; and (ii) transferring excessive vibrations to the operator's station through the frame of the vibration compacting machine.

The present invention is also directed to a vibration compacting machine that includes a frame, a leading drum and a trailing drum. The leading and trailing drums are rotatably mounted to the frame and engage the ground that the vibration compacting machine is riding on. The leading drum includes a first eccentric assembly that is rotatably mounted inside the leading drum and the trailing drum includes a second eccentric assembly that is rotatably mounted inside the trailing drum. The first eccentric assembly is driven by a first motor and the second eccentric assembly is driven by a second motor. A control delays the startup of one of the first and second motors for a period of time after starting the other of the first and second motors. Delaying startup of the motor (i) optimizes the horsepower requirement of the engine; (ii) reduces the frequency and intensity of engine power surges; (iii) extends the operating cycles of the vibration compacting machine before refueling is required; and (iv) extends the service life of the engine of the vibration compacting machine by preventing the engine from operating under peak load.

The present invention also relates to a method for controlling the phase relationship between a first eccentric assembly that is mounted within a leading drum and a second eccentric assembly that is mounted within a trailing drum, the method comprising: driving the first eccentric assembly with a first motor; driving the second eccentric assembly with a second motor; and adjusting the speed of the first motor relative to the second motor to keep the first and second eccentric assembly from moving in-phase with one another.

In another form, the present invention includes a method for controlling the phase relationship between a first eccentric assembly that is mounted within a leading drum and a second eccentric assembly that is mounted within a trailing drum and driven in series with the first eccentric assembly by a hydraulic pump, the method comprising: driving the first eccentric assembly with a first motor; driving the second eccentric assembly with a second motor; sensing the first and second eccentric assemblies; and adjusting the speed of the first motor relative to the second motor by bypassing hydraulic oil from one of the first and second motors to the other of the first and second motors to keep the first and second eccentric assembly from moving in-phase with one another.

The present invention is also directed to a method of minimizing horsepower drain when initiating vibrations in a vibration compacting machine, the method comprising: driving a first eccentric assembly that is mounted within a leading drum on the vibration compacting machine by starting a first motor; and driving a second eccentric assembly that is mounted within a trailing drum on the vibration compacting machine by starting a second motor after the first motor has started.

Other features and advantages of the invention will become apparent to those skilled in the art upon review of the following detailed description, claims, and drawings.

### BRIEF DESCRIPTION OF THE DRAWINGS

FIG. 1 is a perspective view illustrating a vibration compacting machine of the present invention.

FIG. 2 is a partially sectioned side view illustrating an in-phase condition.

FIG. 3 is a view similar to FIG. 2 illustrating an out-of-phase condition.

FIG. 4 is a schematic view illustrating a control system and a single hydraulic pump of the vibration compacting machine of FIG. 1.

FIG. 5 is a view similar to FIG. 4 illustrating a control system with first and second hydraulic pumps.

Before one embodiment of the invention is explained in detail, it is to be understood that the invention is not limited in its application to the details of construction and the arrangements of the components set forth in the following description or illustrated in the drawings. The invention is capable of other embodiments and of being practiced or being carried out in various ways. Also, it is understood that the phraseology and terminology used herein is for the purpose of description and should not be regarded as limiting. The use of “including” and “comprising” and variations thereof herein is meant to encompass the items listed thereafter and equivalents thereof as well as additional items. The use of “consisting of” and variations thereof herein is meant to encompass only the items listed thereafter. The use of letters to identify elements of a method or process is simply for identification and is not meant to indicate that the elements should be performed in a particular order.

### DETAILED DESCRIPTION

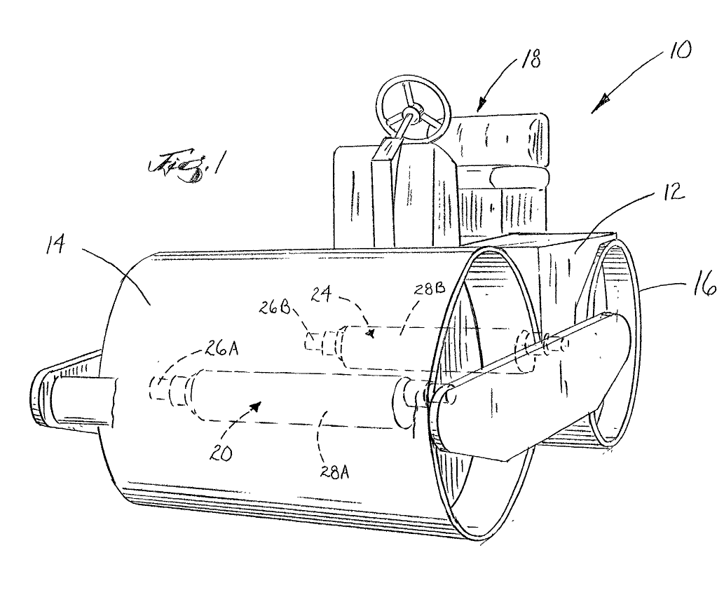

FIG. 1 illustrates a vibration compacting machine 10 of the present invention. The vibration compacting machine 10 includes a frame 12, a leading drum 14 and a trailing drum 16. The leading drum 14 is rotatably mounted to the forward end of the frame 12 and the trailing drum 16 is rotatably mounted to the rearward end of the frame 12. The vibration compacting machine 10 also includes an operator's station 18 that is connected to the frame 12 at a position substantially above and between the leading and trailing drums 14, 16 such that an operator located in the operator's station 18 is sufficiently elevated above the vibration compacting machine 10 to view the area ahead of the leading drum 14. It should be noted that although the positions of the leading drum and the trailing drum are illustrated and described in relation to the vibration compacting machine moving in the forward direction, the positions of the leading drum and the trailing drum would be reversed if the vibration compacting machine was being operated in a reverse direction.

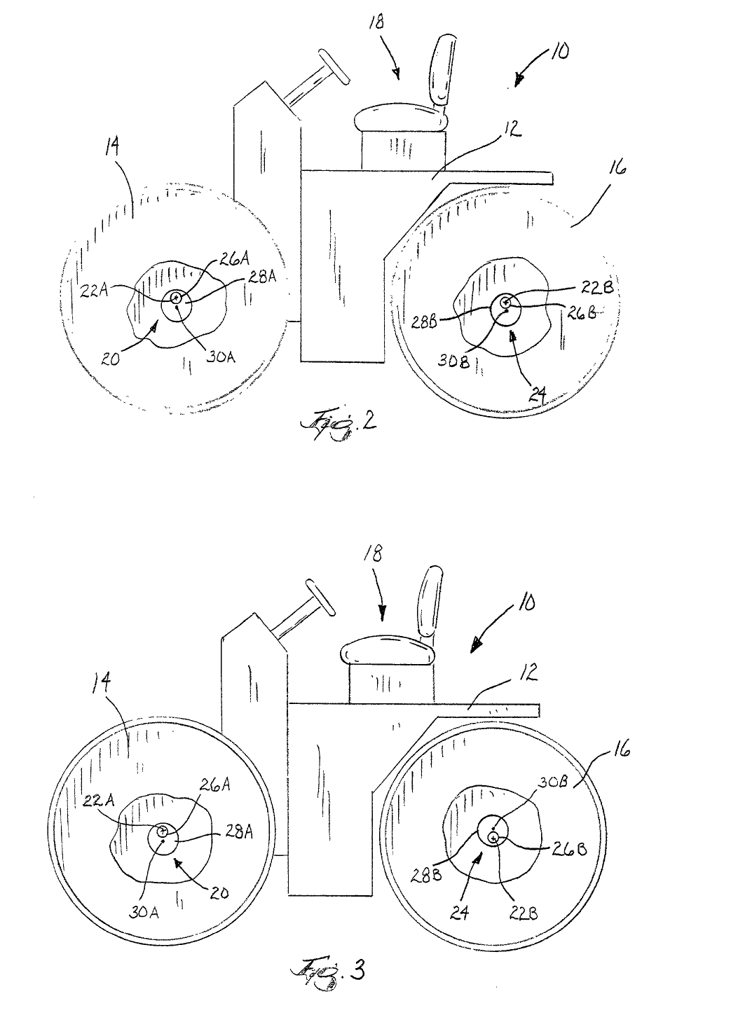

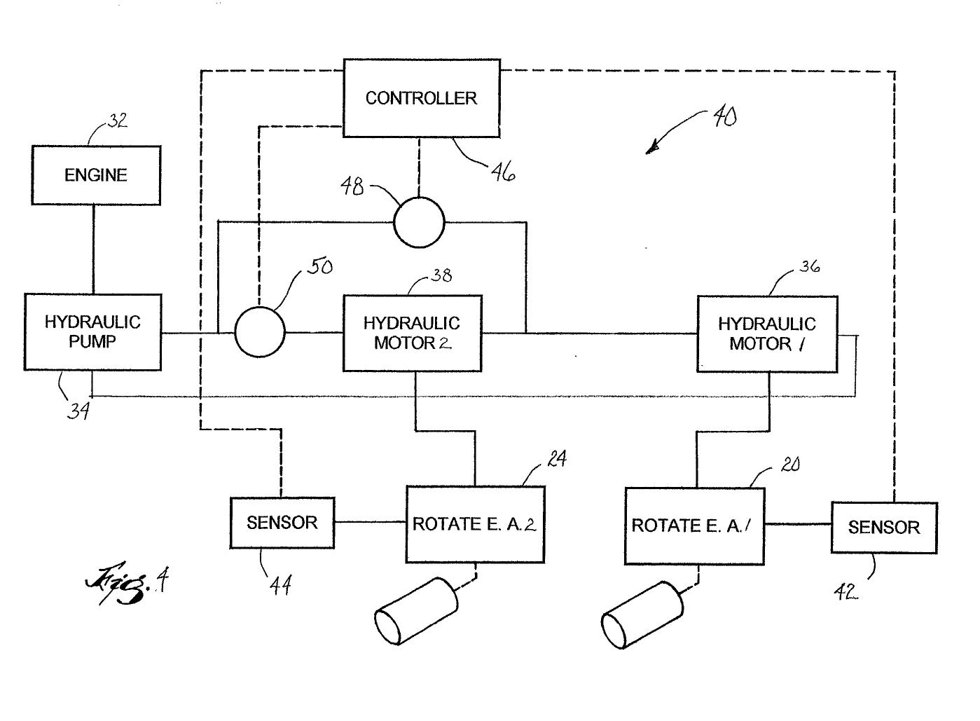

Referring now also to FIGS. 2 and 3, the leading drum 14 includes a first eccentric assembly 20 that is mounted for rotation about an axis 22A within the leading drum 14. The trailing drum 16 includes a second eccentric assembly 24 that is mounted for rotation about an axis 22B within the trailing drum 16. Rotating the first and second eccentric assemblies 20, 24 creates eccentric moments that cause vibrations which are transferred to the respective leading and trailing drums 14, 16. The leading and trailing drums 14, 16 transfer these vibrations to the ground in order to level paved and unpaved surfaces.

Each eccentric assembly 20, 24 includes a shaft 26A, 26B and an eccentric weight 28A, 28B. The eccentric weights 28A, 28B are coupled to the shaft 26A, 26B such that a center of gravity 30A, 30B of each eccentric assembly 20, 24 is located a distance from the axis of rotation 22A, 22B. As used herein, the position of each center of gravity 30A, 30B with respect to the axis of rotation 22A, 22B will designate the angular or phase position of the eccentric assembly 20, 24. When each center of gravity 30A, 30B is directly below the respective axis of rotation 22A, 22B, the phase position of the eccentric assembly 20, 24 is 0 degrees and when each center of gravity 30A, 30B is directly above the respective axis of rotation 22, the phase position is 180 degrees.

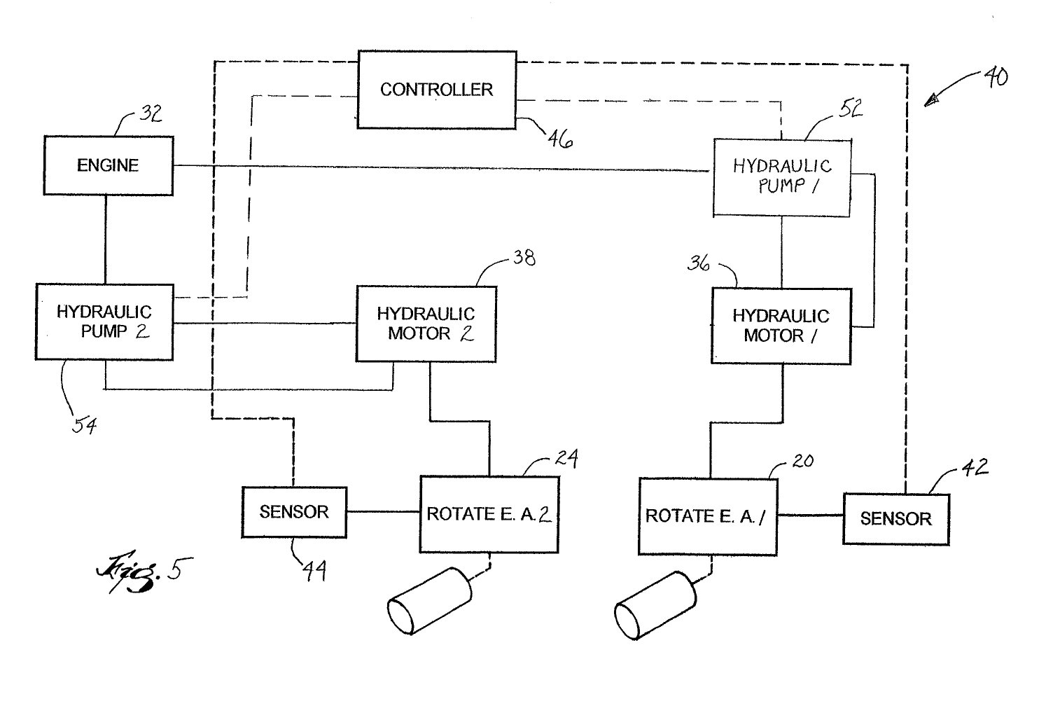

As shown schematically in FIG. 4, the vibration compacting machine 10 includes an engine 32 that is mounted to the frame 12. The engine 32 drives a hydraulic pump 34 that is also mounted to the frame 12. The hydraulic pump 12 supplies hydraulic oil to a first hydraulic motor 36 that drives the first eccentric assembly 20 and a second hydraulic motor 38 that drives the second eccentric assembly 24. The second hydraulic motor 38 is connected in series with the first hydraulic motor 36. The first and second hydraulic motors 36, 38 are preferably mounted within the leading and trailing drums 14, 16 and rotate the first and second eccentric assemblies 20, 24 such that the first and second eccentric assemblies 20, 24 generate vibrations which are transferred to the drums 14, 16.

The first and the second eccentric assemblies 20, 24 are driven separately by the hydraulic motors 36, 38 such that the first and second eccentric assemblies 20, 24 rotate at different speeds. Since the motors 36, 38 are connected in series, the speed of the upstream motor 38 is greater than the speed of the downstream motor 36 because the downstream motor 36 has increased losses compared to the upstream motor 38. The unequal speeds of the first and second eccentric assemblies 20, 24 cause the first and second eccentric assemblies 20, 24 to consistently move in and out of phase with each other.

The words “in phase” are used herein to designate that the first eccentric assembly 20 and the second eccentric assembly 24 are located in substantially the same phase position. As shown in FIG. 2, the eccentric assemblies 20, 24 are in phase because both eccentric assemblies 20, 24 are located in the 0 degree position such that there is a 0 degree difference between the eccentric assemblies 20, 24. The phrase “out of phase” is similarly used to designate that the first and second eccentric assemblies 20, 24 are located at different phase positions. As shown in FIG. 3, the first and second eccentric assemblies 20, 24 are out of phase because the first eccentric assembly 20 is located at the 0 degree position and the second eccentric assembly 24 is located at the 180 degree position such that a 180 degree angle exists between them.

Several problems develop from rotating the eccentric assemblies 20, 24 in phase, or nearly in phase, with each other. First, the eccentric assemblies 20, 24 emit an amplified noise that is offensive to the operator positioned at the operator's station 18. In addition, the eccentric assemblies 20, 24 transfer significant vibrations to the operator station 18 of the vibration compacting machine 10 through the frame 12. The increased vibrations cause discomfort to the operator and decrease the machine component life of mechanical and electronic systems on the vibration compacting machine 10 that are sensitive to shock and vibration.

Referring again to FIG. 4, the vibration compacting machine 10 includes a phase control system 40 that monitors the eccentric assemblies 20, 24 and maintains the eccentric assemblies 20, 24 in an out of phase position to reduce the effect of the above mentioned problems. The phase control system 40 includes a first sensor 42 that produces an input signal corresponding to the location of the first eccentric assembly 20, and a second sensor 44 that produces an input signal corresponding to location of the second eccentric assembly 24. The sensors 42, 44 preferably sense the speed of the first and second eccentric assemblies 20, 24 and the phase relationship between the first and second eccentric assemblies 20, 24 using a sensor such as a Hall Effect sensor or a variable reluctance sensor. The sensors 42, 44 may also sense the acceleration of the first and second eccentric assemblies 20, 24 with an accelerometer. Alternatively, the sensors 42, 44 can sense the volume of the sound generated by the first and second eccentric assemblies 20, 24 with a microphone. It should be noted that a single microphone could be used to monitor the volume of the eccentric assemblies 20, 24 when the microphone is positioned between the drums 14, 16, preferably near the operator's station 18.

The vibration compacting machine 10 also includes a control 46 that varies the speed of the first and second motor 36, 38 relative to each other to move the eccentric assemblies 20, 24 out of phase based on information received from the input signals of the sensors. The control 46 adjusts the speed of the first and second motors 36, 38 by sending an output signal that opens a bypass valve 48 to allow hydraulic oil to bypass the second hydraulic motor 38 and travel directly to the first hydraulic motor 36. As hydraulic oil bypasses the second hydraulic motor 38, the first hydraulic motor 36 increases speed and the second hydraulic motor 38 decreases speed such that the eccentric assemblies 20, 24 move toward a more out of phase position.

The control 46 is preferably a microprocessor that determines whether or not the phased relationship between the eccentric assemblies 20, 24 are within acceptable predetermined limits. The control 46 also determines the rate the phased relationship is moving away from the nominal acceptable limit or towards the nominal acceptable limit. Based on this information, the control 46 delivers an output signal to modify the phased relationship of the eccentric assemblies 20, 24. The control 46 tracks the effects of the signals on the eccentric assemblies 20, 24 so that an improved change can be made in the future for a similar phased relationship. The control 46 repeats this iterative process such that the control 46 realizes an ideal output signal for each phased relationship between the eccentric assemblies 20, 24. The control 46 stores these ideal output signals for each individual machine in order to optimize all of the output signals for that specific vibration compacting machine 10.

The control 46 preferably delays startup of the second hydraulic motor 38 for a period of time after starting the first hydraulic motor 36 in order to reduce the negative effects of excessive engine horsepower drain that results when both hydraulic motors 36, 38 are started simultaneously. In one of many forms, the phase control system 40 includes a first valve 50 that is positioned between the hydraulic pump 34 and the second hydraulic motor 38 and a bypass valve 48 that is positioned between the hydraulic pump 34 and the first hydraulic motor 36 along a fluid path which bypasses the second hydraulic motor 38. During startup of the eccentric assemblies 20, 24, the first valve 50 is closed and the bypass valve 48 is opened to supply hydraulic oil to the first hydraulic motor 36 to initiate rotation of only the first eccentric assembly 20. After a defined period of time, the first valve 50 is opened to begin rotation of the second hydraulic motor 38 along with the first hydraulic motor 36. The start up of the second hydraulic motor 38 is preferably delayed. The appropriate timing for the delay is determined by the base distance between the drums 14, 16 and the rolling speed of the vibration compacting machine. The trailing drum's vibrations are preferably initiated at the same location on the pavement surface as the location that the leading drum began generating vibrations.

The control 46 assures that the horsepower requirement on the compactor's engine 32 will be optimized since the leading drum's 14 power demand from the engine 32 will have peaked and dropped before power is required for the trailing drum 16. The method and vibration compacting machine 10 of the present invention (i) reduce total peak engine 32 horsepower; (ii) extend engine 32 life due to diminished operation under peak power load; (iii) increase operating cycles of the vibration compacting machine before refueling is required; and (iv) reduce the frequency and intensity of engine 32 power surges.

FIG. 5 illustrates an alternative form of the invention that includes an engine 32, and first and second hydraulic pumps 52, 54 that are independently driven by the engine 32. The first hydraulic pump 52 supplies hydraulic oil to the first hydraulic motor 36 and the second hydraulic pump 54 supplies hydraulic oil to the second hydraulic motor 38. In this embodiment, the control 46 independently adjusts flow of hydraulic oil to the first and second hydraulic pumps 52, 54 in order to control the speed of the first eccentric assembly 20 independently from speed of the second eccentric assembly 24. The control 46 also delays the startup of the second hydraulic motor 38 until after the first hydraulic motor 36 is started by preventing the flow of hydraulic oil from the second hydraulic pump 54 to the second hydraulic motor 38. In an alternative form, the control 40 delays the startup of the first hydraulic motor 36 until after the second hydraulic motor 38 is started by preventing the flow of hydraulic oil from the first hydraulic pump 52 to the first hydraulic motor 36.

We claim:

1. A vibration compacting machine comprising:
a frame;
a leading drum rotatably mounted to the frame, the leading drum including a first eccentric assembly rotatably mounted inside the leading drum;
a first motor for driving the first eccentric assembly;
a trailing drum rotatably mounted to the frame, the trailing drum including a second eccentric assembly rotatably mounted inside the trailing drum;
a second motor for driving the second eccentric assembly;
a control that adjusts the speed of the first motor and the second motor relative to one another.

2. The vibration compacting machine of claim 1, wherein the first motor is inside of the leading drum and the second motor is inside of the trailing drum.

3. The vibration compacting machine of claim 1, wherein the first and second motors are hydraulic motors.

4. The vibration compacting machine of claim 3, wherein the first and second hydraulic motors are connected in series to a hydraulic pump.

5. The vibration compacting machine of claim 4, wherein the control adjusts the speed of the first and second motors by bypassing hydraulic oil from one of the first and second motors to the other of the first and second motors.

6. The vibration compacting machine of claim 1, wherein the control adjusts the speed in response to a sensor.

7. The vibration compacting machine of claim 6, wherein the sensor senses the vibration level created by the first and second eccentric assemblies.

8. The vibration compacting machine of claim 7, wherein the control determines if the vibration level is moving away from acceptable limits and adjusts the speed of the first and second motor based on movement of the vibration level.

9. The vibration compacting machine of claim 8, wherein the control records an effect of each adjustment to the speeds of the first and second motors in order to make better adjustments to the first and second motors when a similar phasing condition exists in the future.

10. The vibration compacting machine of claim 6, wherein the sensor senses the speed of the first and second eccentric assemblies and the phase relationship between the first and second eccentric assemblies.

11. The vibration compacting machine of claim 10, wherein the sensor is a Hall Effect sensor.

12. The vibration compacting machine of claim 10, wherein the sensor is a variable reluctance sensor.

13. The vibration compacting machine of claim 6, wherein the sensor senses the volume of the sound created by the first and second eccentric assemblies.

14. The vibration compacting machine of claim 13, wherein the sensor is a microphone.

15. The vibration compacting machine of claim 6, wherein the sensor senses the acceleration of the first and second eccentric assemblies.

16. The vibration compacting machine of claim 15, wherein the sensor is an accelerometer.

17. The vibration compacting machine of claim 1, wherein the control adjusts the phased relationship between the first and second eccentric assemblies.

18. The vibration compacting machine of claim 1, wherein the control is a microprocessor.

19. A vibration compacting machine comprising:
a frame;
a leading drum rotatably mounted to the frame, the leading drum including a first eccentric assembly rotatably mounted inside the leading drum;
a first hydraulic motor inside of the leading drum for driving the first eccentric assembly;
a trailing drum rotatably mounted to the frame, the trailing drum including a second eccentric assembly rotatably mounted inside the trailing drum;
a second hydraulic motor inside of the trailing drum for driving the second eccentric assembly, the second hydraulic motor being connected in series with the first hydraulic motor to a hydraulic pump;
a control that adjusts the speed of the first motor and the second motor relative to one another by bypassing hydraulic oil from one of the first and second motors to the other of the first and second motors.

20. A vibration compacting machine for compacting paved or unpaved ground surfaces comprising:
a frame;
a leading drum rotatably mounted to the frame for compacting the ground surface, the leading drum including a first eccentric assembly rotatably mounted inside the leading drum such that rotation of the first eccentric assembly creates an eccentric moment;
a first motor for rotating the first eccentric assembly to generate vibrations that are transferred to the leading drum;
a trailing drum rotatably mounted to the frame for compacting the ground surface in addition to the leading drum, the trailing drum including a second eccentric assembly rotatably mounted inside the trailing drum such that rotation of the second eccentric assembly creates an eccentric moment;
a second motor for rotating the second eccentric assembly to generate vibrations that are transferred to the trailing drum;
a control that adjusts the speed of the first motor and the second motor relative to one another to keep the first eccentric assembly from running in phase with the second eccentric assembly thereby preventing the eccentric assemblies from emitting an amplified noise that is offensive to the operator and transferring excessive vibrations to the operator's station through the frame of the vibration compacting machine.

21. A method for controlling the phase relationship between a first eccentric assembly that is mounted within a leading drum and a second eccentric assembly that is mounted within a trailing drum, the method comprising:
driving the first eccentric assembly with a first motor;
driving the second eccentric assembly with a second motor; and
adjusting the speed of the first motor relative to the second motor to keep the first and second eccentric assembly from moving in-phase with one another.

22. The method of claim 21, wherein the first and second motors are driven in series by a hydraulic pump and adjusting the speed of the first motor relative to the second motor includes bypassing hydraulic oil from one of the first and second motors to the other of the first and second motors.

23. The method of claim 21, further comprising sensing the first and second eccentric assemblies to facilitate adjusting the speed of the first motor relative to the second motor.

24. The method of claim 23, wherein sensing the first and second eccentric assemblies includes sensing a vibration level created by the first and second eccentric assemblies.

25. The method of claim 24, wherein adjusting the speed of the first motor relative to the second motor includes determining if the vibration level is moving away from acceptable limits, and adjusting the speed of the first and second motors based on movement of the vibration level.

26. The method of claim 25, wherein adjusting the speed includes recording an effect of each adjustment to the speeds of the first and second motors in order to make better adjustments to the first and second motors when a similar phasing condition exists in the future.

27. The method of claim 23, wherein sensing the first and second eccentric assemblies includes sensing the speed of the first and second eccentric assemblies.

28. The method of claim 23, wherein sensing the first and second eccentric assemblies includes sensing the phase relationship between the first and second eccentric assemblies.

29. The method of claim 23, wherein sensing the first and second eccentric assemblies includes sensing the volume of the sound created by the first and second eccentric assemblies.

30. The method of claim 23, wherein sensing the first and second eccentric assemblies includes sensing the acceleration of the first and second eccentric assemblies.

31. The method of claim 21, wherein adjusting the speed of the first motor relative to the second motor includes adjusting the phased relationship between the first and second eccentric assemblies.

32. A method for controlling the phase relationship between a first eccentric assembly that is mounted within a leading drum and a second eccentric assembly that is mounted within a trailing drum and driven in series with the leading drum by a hydraulic pump, the method comprising:
driving the first eccentric assembly with a first motor;
driving the second eccentric assembly with a second motor;
sensing the first and second eccentric assemblies; and
adjusting the speed of the first motor relative to the second motor by bypassing hydraulic oil from one of the first and second motors to the other of the first and second motors to keep the first and second eccentric assembly from moving in-phase with one another.

33. A vibration compacting machine comprising:
a frame;
a leading drum rotatably mounted to the frame, the leading drum including a first eccentric assembly rotatably mounted inside the leading drum;
a first motor for driving the first eccentric assembly;
a trailing drum rotatably mounted to the frame, the trailing drum including a second eccentric assembly rotatably mounted inside the trailing drum;
a second motor for driving the second eccentric assembly;
a control that delays the startup of one of the first and second motors for a period of time after starting the other of the first and second motors.

34. The vibration compacting machine of claim 33, wherein the second motor is started after the first motor is started.

35. The vibration compacting machine of claim 34, wherein the second motor is started when the trailing drum has moved into approximately the same position the leading drum was in when the first motor was started.

36. The vibration compacting machine of claim 34, wherein the second motor is started when the trailing d rum has traveled a distance approximately equal to the distance between the leading drum and the trailing drum such that the eccentric assemblies initiate vibration at approximately the same location.

37. The vibration compacting machine of claim 34, wherein the second motor is started after the power demand of the first motor has peaked and dropped.

38. A method of minimizing horsepower drain when initiating vibrations in a vibration compacting machine, the method comprising:
driving a first eccentric assembly that is mounted within the leading drum on the vibration compacting machine by starting a first motor; and
driving a second eccentric assembly that is mounted within a trailing drum on the vibration compacting machine by starting a second motor after the first motor has started.

39. The method of claim 38, wherein driving a second eccentric assembly includes starting the second motor at least 1 second after starting the first motor.

40. The method of claim 38, wherein driving a second eccentric assembly includes starting the second motor after the trailing drum has moved.

41. The method of claim 38, further comprising moving the trailing drum into approximately the same position the leading drum was in when the first motor was started before starting the second motor.

42. The method of claim 38, further comprising moving the trailing drum a distance approximately equal to the distance between the leading drum and the trailing drum after the first motor is started and before the second motor is started.

43. The method of claim 38, wherein driving a second eccentric assembly includes starting the second motor after the power demand of the first motor has peaked and dropped.
